(19) United States
(12) Patent Application Publication
(10) Pub. No.: US 2026/0154434 A1
(43) Pub. Date: Jun. 4, 2026

(54) STORAGE DEVICE

(71) Applicant: Samsung Electronics Co., Ltd., Suwon-si (KR)

(72) Inventors: Yuri HONG, Suwon-si (KR); Jisoo KIM, Suwon-si (KR); Younsung CHU, Suwon-si (KR)

(21) Appl. No.: 19/290,716

(22) Filed: Aug. 5, 2025

(30) Foreign Application Priority Data
Dec. 4, 2024 (KR) 10-2024-0178632

(51) Int. Cl. G06F 21/62; G06F 21/74

(52) U.S. Cl. CPC G06F 21/6218; G06F 21/74

(57) ABSTRACT

A storage device includes a memory device, and a storage controller including a security management module for managing security data of the storage device. The security management module includes a security manager that receives a command related to the security data, determines a current security mode of the storage device in response to receiving the command, and controls access to the security data based on the current security mode. The current security mode includes one of a first security mode, in which the security manager allows access to the security data, a second security mode, in which the security manager allows limited access to the security data, and a third security mode, in which the security manager blocks access to the security data.

### CROSS-REFERENCE TO RELATED APPLICATION

This application claims priority to Korean Patent Application No. 10-2024-0178632, filed in the Korean Intellectual Property Office on Dec. 4, 2024, the entire contents of which are hereby incorporated by reference.

### BACKGROUND

### Technical Field

The present disclosure relates to a storage device.

### Description of the Related Art

Recently, storage devices, such as a solid state drive (SSD), using a memory device have been widely used. Such storage devices have excellent stability and durability as they do not have mechanical driving parts, and have the advantage of being very fast in accessing information and consuming little power. Today, as electronic circuits have been applied to various types of systems such as automobiles, aircraft, and drones as well as electronic systems such as laptops, storage devices have also been used for a variety of types of systems.

Meanwhile, storage devices may store sensitive security data such as encryption keys, authentication information, and security protocol parameters. To safely manage such security data, security technologies such as authentication, encryption, and access control are required. In addition, a systematic system is needed to efficiently protect and manage the security data in various situations and maintain the integrity and the confidentiality of the data.

The above-described information is intended to improve understanding of the background of the present disclosure and may include information not contained in a related art.

### SUMMARY

The present disclosure relates to a storage device.

According to some embodiments, a storage device comprises a memory device, and a storage controller comprising a security management module for managing security data of the storage device, wherein the security management module comprises a security manager that is configured to receive a command related to the security data, determine a current security mode of the storage device in response to receiving the command, and control access to the security data based on the current security mode, wherein the current security mode comprises one of a first security mode, in which the security manager is configured to allow access to the security data, a second security mode, in which the security manager is configured to allow limited access to the security data, and a third security mode, in which the security manager is configured to block access to the security data.

According to some embodiments, a storage device comprises a memory device, and a storage controller comprising a first processor core for controlling non-security-related operations of the storage device, a second processor core for controlling security operations of the storage device, and a security management module configured to be accessed by the second processor core, wherein the security management module comprises a security memory device configured to store at least some of security data of the storage device and a security data buffer configured to temporarily store first security data read out from the security memory device, wherein the first security data is a portion of the security data stored by the security memory device, the second processor core is configured to receive a command related to the security data, determine a current security mode of the storage device in response to receiving the command related to the security data, and determine whether to perform an operation related to the security memory device based on the current security mode, and the second processor core is configured to read out the first security data temporarily stored in the security data buffer when performing a reading operation on the security memory device.

According to some embodiments, a storage device comprises a memory device, and a storage controller comprising a first processor core for controlling non-security-related operations of the storage device, a second processor core for controlling security operations of the storage device, and a security management module configured to be accessed by the second processor core, wherein the security management module comprises a security memory device configured to store a first portion of security data of the storage device, an external memory device configured to store a second portion of the security data, wherein the external memory device is configured to be accessed by the security manager, and a security data buffer configured to temporarily store security data read out from the security memory device or the external memory device, wherein a current security mode of the storage device comprises one of an unauthenticated mode, an authenticated mode, a zeroised mode, a debug mode, and an abnormal mode, the second processor core is configured to receive a command related to the security data, determine the current security mode of the storage device in response to receiving the command related to the security data, and control access to the security memory device and the external memory device based on the determined current security mode, and the second processor core is configured to read out the security data temporarily stored in the security data buffer when performing a reading operation on the security memory device or the external memory device.

According to various embodiments of the present disclosure, access to security data may be controlled based on the current security mode of the storage device, thereby effectively preventing security threats such as unauthorized access and data manipulation.

According to various embodiments of the present disclosure, it may be possible to maintain the confidentiality and the integrity of security data and effectively improve the reliability and the security level of the storage device.

According to various embodiments of the present disclosure, it may be possible to quickly respond to a request for access to security data and efficiently perform operations on the security data.

According to various embodiments of the present disclosure, it may be possible to unify the storage and management of security data and efficiently control access to the security data. As a result, it may be possible to maintain the integrity and the confidentiality of the security data.

The effects of the present disclosure are not limited to those described above. The following description of the present disclosure would allow a person having ordinary skill in the art to clearly understand other technical effects thereof not mentioned above.

### BRIEF DESCRIPTION OF THE DRAWINGS

FIG. 1 is a block diagram for illustrating a storage system according to some embodiments of the present disclosure.

FIG. 2 is a block diagram for illustrating a storage controller according to some embodiments of the present disclosure.

FIG. 3 is a flowchart for illustrating an example of a method of operating a security management module according to some embodiments of the present disclosure.

FIG. 4 shows security modes of a storage device and what operation a security manager is permitted to perform in each security mode according to one embodiment of the present disclosure.

FIG. 5 is a block diagram for illustrating the storage controller according to some embodiments of the present disclosure.

FIG. 6 is a view for illustrating an example of a security data address table according to one embodiment of the present disclosure.

FIG. 7 is a block diagram for illustrating the storage device according to some embodiments of the present disclosure.

FIG. 8 is a view for illustrating an example of a security data address table according to one embodiment of the present disclosure.

FIG. 9 is a block diagram for illustrating the storage system according to some embodiments of the present disclosure.

FIG. 10 is a flowchart for illustrating an example of a method of performing a registration operation related to security data according to some embodiments of the present disclosure.

FIG. 11 is a flowchart for illustrating an example of a method of performing a writing operation related to security data according to some embodiments of the present disclosure.

FIG. 12 is a flowchart for illustrating an example of a method of performing a reading operation related to security data according to some embodiments of the present disclosure.

FIG. 13 illustrates an example of how a security mode of a storage device is switched according to some embodiments of the present disclosure.

FIG. 14 is a flowchart for illustrating an example of a method of switching a security mode according to some embodiments of the present disclosure.

FIG. 15 is a flowchart for illustrating an example of a method of switching a security mode according to some embodiments of the present disclosure.

FIG. 16 is a flowchart for illustrating an example of a method of switching a security mode according to some embodiments of the present disclosure.

FIG. 17 is a view for illustrating an operation method of a storage system according to some embodiments of the present disclosure.

FIG. 18 is a block diagram for showing an example of how a storage system according to one embodiment of the present disclosure is applied to an SSD system.

### DETAILED DESCRIPTION

Throughout the specification, when a component is described as “including” a particular element or group of elements, it is to be understood that the component is formed of only the element or the group of elements, or the element or group of elements may be combined with additional elements to form the component, unless the context clearly and/or explicitly describes the contrary. Further, phrases such as at least one of A and B, or at least one of A or B, can comprise A and B, or A or B.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

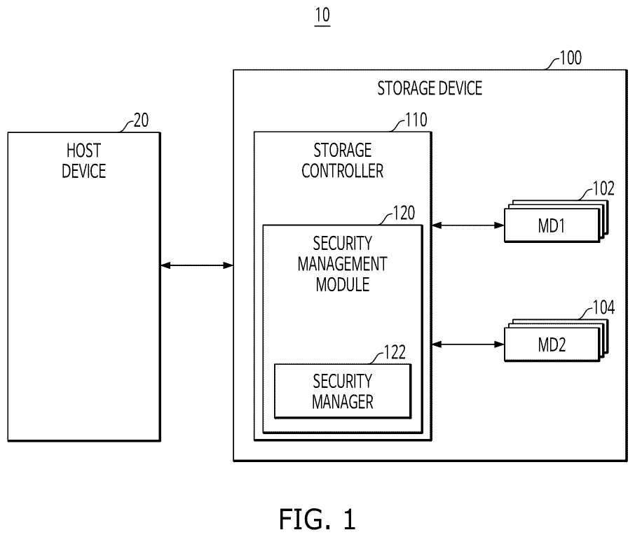

Hereinafter, various embodiments of the present disclosure will be described with reference to FIGS. 1 to 18. The same reference numerals may refer to the same components throughout the present disclosure.

FIG. 1 is a block diagram for illustrating a storage system 10 according to some embodiments of the present disclosure.

Referring to FIG. 1, the storage system 10 may include a host device 20 and a storage device 100 designed to exchange data with the host device 20. The storage system 10 may be one of devices that store data, such as a mobile phone, a smart phone, an MP3 player, a laptop computer, a desktop computer, a game console, a TV, a tablet PC, or an in-vehicle infotainment system.

The host device 20 may control the overall operation of the storage system 10. The host device 20 may execute an operating system and various applications for an Internet browser, games, videos, cameras, etc. For example, the operating system running on the host device 20 may include a file system for managing files and a device driver for controlling peripherals including the storage device 100 at the operating system level.

The host device 20 may include at least one of an application processor, a central processing unit, and a microprocessor. The host device 20 may include a processor including one single processor core or a processor including a plurality of processor cores. In one embodiment, the storage system 10 may be included in a mobile device, and the host device 20 may be formed as an application processor. In one embodiment, the host device 20 may be formed as a system-on-a-chip (SoC) and thus may be embedded in an electronic device.

The host device 20 may communicate with the storage device 100 through various interfaces. For example, the storage device 100 and the host device 20 may be connected to each other based on the interface protocol defined by the universal flash storage (UFS) standard, so the storage device 100 may be a UFS device while the host device 20 may be a UFS host. However, the present disclosure is not limited thereto, and the storage device 100 and the host device 20 may be connected to each other based on a range of standard interfaces.

The host device 20 may control data processing operations performed by the storage device 100, such as data reading operations or data writing operations. The host device 20 may transmit a command for a data processing operation by the storage device 100 and data to the storage device 100, and the storage device 100 may perform the data processing operation according to the command and transmit a response indicating the result of carrying out the operation to the host device 20. The host device 20 may transmit commands related to the general operations of the storage device 100, such as a reading command and a writing command, to the storage device 100. In addition, the host device 20 may transmit, to the storage device 100, commands based on the security protocol of the interface with the storage device 100, such as a security input command and a security output command for the security function of the storage device 100. The storage device 100 may transmit, to the host device 20, data generated by performing an operation according to a request from the host device 20 and/or data read from a memory device.

The storage device 100 may be manufactured as one of various types of storage devices 100 based on a host interface, through which it communicates with the host device 20. For example, the storage device 100 may be one of a variety of types of storage devices, such as a solid state driver (SSD), a multimedia card in the form of an MMC, an eMMC, an RS-MMC, or a micro-MMC, a secure digital card in the form of SD, mini-SD, or micro-SD, a universal storage bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-E) card, a compact flash (CF) card, a smart media card, and a memory stick.

When the storage device 100 is an SSD, it may be a device following the non-volatile memory express (NVMe) standard. When the storage device 100 is an embedded memory or an external memory, it may be a device following the universal flash storage (UFS) or embedded multi-media card (eMMC) standard. The host device 20 and the storage device 100 may each generate packets according to the adopted standard protocol and transmit them.

The storage device 100 may be manufactured as one of various types of packages. For example, the storage device 100 may be manufactured as one of a range of types of packages, such as a package on package (POP), a system in package (SIP), a system on chip (SOC), a multi-chip package (MCP), a chip on board (COB), a wafer-level fabricated package (WFP), and a wafer-level stack package (WSP).

The storage device 100 may include at least one of a storage controller 110, a first memory device 102, and a second memory device 104. FIG. 1 shows the storage device 100 including a plurality of first memory devices 102 and a plurality of second memory devices 104. However, this is only an exemplary embodiment, and the present disclosure is not limited thereto. For example, the first memory device 102 may comprise a single first memory device, and the second memory device 104 may comprise a single second memory device. In some embodiments, the storage device 100 may comprise a single memory device, for example, the first memory device 102.

The storage controller 110 may control the overall operation of the storage device 100. For example, the storage controller 110 may control data writing and/or reading operation of the storage device 100 in response to a command received from the host device 20.

The first memory device 102 and/or the second memory device 104 may store data received from the storage controller 110. In an exemplary embodiment, the first memory device 102 may include a flash memory as a nonvolatile memory device. In some embodiments, the first memory device 102 may include a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or a similar memory. When the first memory device 102 includes a flash memory, the flash memory may include a 2D NAND memory array and/or a 3D or vertical NAND (VNAND) memory array. In other embodiments, the first memory device 102 may include various other types of nonvolatile memory devices.

In an exemplary embodiment, the second memory device 104 may include a volatile memory device. The second memory device 104 may include at least one of volatile memory devices, such as a dynamic random-access memory (DRAM), a static random access memory (SRAM), and a synchronous dynamic random access memory (SDRAM). In other embodiments, the second memory device 104 may include various other types of volatile memory devices.

The storage device 100 may store a range of security data related to maintaining the security of the storage device 100 and/or protecting data stored therein. Such security data may be important data that may involve special management as information designed to perform security functions within the storage device 100 and maintain the security status of the storage device 100. In an exemplary embodiment, the security data may be stored in a specific memory area of the storage device 100 or managed by an internal module of the storage controller 110. For example, the security data may be stored in a security-only memory within the storage controller 110. In one embodiment, data other than the security data may be stored in the first memory device 102 and the second memory device 104, but the present disclosure is not limited thereto.

The security data may refer to any information required to maintain the security of the storage device 100 and/or protect data thereof, and may include a sensitive security parameter (SSP), for example. The security data may include encryption keys used within the storage device 100, such as a private key, a public key, a symmetric key, an asymmetric key, a session key, and a root key. In other embodiments, the security data may include authentication data such as certificate data included in a digital certificate, a secret authentication token, and biometric authentication data. In other embodiments, the security data may include various types of information related to managing the security status of the storage device 100 and protecting data thereof. Such information may include parameters of a security protocol, a secure boot key, a random seed, data used by a hardware security module (HSM), etc.

The storage controller 110 may include a security management module 120 designed to manage security data. The security management module 120 may include a dedicated hardware module separately provided within the storage controller 110 to manage the security data of the storage device 100. The security management module 120 may store a variety of types of security data of the storage device 100. In addition, when an external device such as the host device 20 attempts to access the security data of the storage device 100, the access may be controlled by the security management module 120. In one embodiment, the security management module 120 may determine the current security mode or status of the storage device 100 and control access to the security data based on the current security mode. For example, and as described below, when the storage device 100 is in a first security mode, the host device 20 may be given a first type of access, and when the storage device 100 is in a second security mode, the host device 20 may be given a second type of access. The first security mode may be different from the second security mode, such that the first type of access may be different from the second type of access. In some embodiments, the first type of access may allow for a reading operation wherein the data in question may be read, and the second type of access may allow for a writing operation wherein data may be written to one of the memory devices 102, 104. Additional security modes (e.g., a third security mode, a fourth security mode, etc.), some of which are described herein, are also envisioned. In this way, the security management module 120 may determine the security mode prior to providing access to the security data.

The security management module 120 may include a security manager 122, and the security manager 122 may control access to the security management module 120 and perform operations related to security data. For example, the security manager 122 may receive a command related to security data, and determine the current security mode of the storage device 100 in response to receiving the command related to the security data and control access to the security management module 120 and/or the security data based on the current security mode of the storage device 100. For another example, based on the current security mode of the storage device 100, the security manager 122 may perform the operation of reading security data from a memory device storing the security data, writing security data to a memory device, etc. The reading operation (e.g., reading security data from the memory device) may comprise retrieving or accessing the security data without modifying the security data, such that the security data does not change. The writing operation (e.g., writing security data to the memory device) may comprise adding, modifying, or updating the security data, such that existing security data may be altered, or new security data may be added.

The security mode of the storage device 100 may be switched depending on conditions such as the status of the storage device 100 and a specific event, and the security manager 122 may access security data or control access thereto differently in each security mode. For example, in a particular security mode, the security manager 122 may allow access to security data and carry out operations on the security data, but, in another security mode, may restrict or block access to the security data. A specific description of how the security manager 122 accesses security data or controls access thereto in each security mode will be provided below.

According to various embodiments of the present disclosure, access to security data may be controlled according to the current security mode of the storage device 100, thereby effectively preventing security threats such as unauthorized access and data manipulation. In particular, even when a security attack, etc. is detected in the storage device 100, or the storage device 100 is in a state where it is easily exposed to a security threat, the storage controller 110 or the security manager 122 may monitor the state of the storage device 100 to switch the security mode thereof and control access to the security data, thereby preventing leakage or unauthorized modification of sensitive data. As a result, it may be possible to maintain the confidentiality and integrity of security data and effectively strengthen the reliability and security level of the storage device 100.

Although FIG. 1 illustrates the storage device 100 including both the first memory device 102 and the second memory device 104, the present disclosure is not limited thereto. In an exemplary embodiment, the storage device 100 may include the first memory device 102 but may not include the second memory device 104. In another embodiment, the storage device 100 may include the second memory device 104 but may not include the first memory device 102. Further, additional memory devices (e.g., a third memory device, a fourth memory device, etc.) may be provided, in addition to one or both of the first memory device 102 and the second memory device 104.

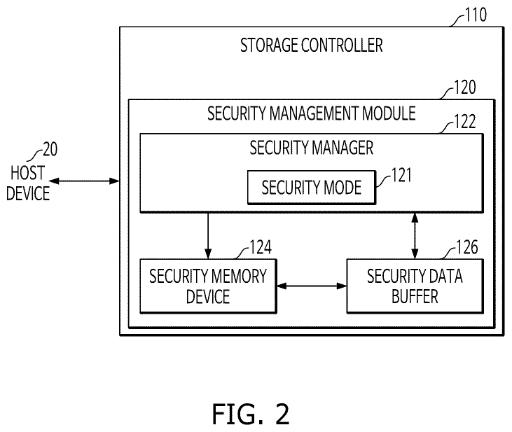

FIG. 2 is a block diagram for illustrating the storage controller 110 according to some embodiments of the present disclosure.

Referring to FIG. 2, the storage controller 110 may include the security management module 120 that manages security data of the storage device 100. The security management module 120 may include the security manager 122 that controls access to security data based on the current security mode of the storage device 100, a security memory device 124 that stores security data, and a security data buffer 126 that temporarily stores security data read from the security memory device 124. Although not shown, the storage controller 110 may further include components for controlling operations on a memory device in addition to the security management module 120.

In one embodiment, the security manager 122 may manage a security mode 121 of the storage device 100. Here, the security mode 121 may be in hardware and/or software. The security manager 122 may monitor the status of the storage device 100 and switch the security mode 121 of the storage device 100. In other embodiments, the security manager 122 may receive a signal related to the status of the storage device 100 from the storage controller 110 and switch the security mode 121 of the storage device 100 based on the received signal.

In one embodiment, the security manager 122 may determine the current security mode of the storage device 100. The security manager 122 may control access to security data or determine whether to perform operations related to the security data based on the current security mode of the storage device 100. For example, the security manager 122 may receive a command related to security data and determine whether to carry out the command related to the security data based on the current security mode of the storage device 100. Here, the command related to the security data may include an operation of writing the security data into the security memory device 124 and/or an operation of reading the security data stored in the security memory device 124, but the present disclosure is not limited thereto. The security manager 122 may perform the command related to the security data when determining that performing of the command related to the security data can be permitted based on the current security mode of the storage device 100.

In one embodiment, the security mode 121 of the storage device 100 may include a plurality of security modes, for example, an unauthenticated mode, an authenticated mode, a zeroised mode, a debug mode, and an abnormal mode, but the present disclosure is not limited thereto.

The unauthenticated mode may indicate that the storage device 100 has not been authenticated by the security management module 120. The unauthenticated mode may be activated as a default mode when the storage device 100 is in an initial state or in a normal state where an authentication procedure has not been performed. When the current security mode of the storage device 100 is the unauthenticated mode, the security manager 122 may block requests for access to security data and operate to block reading operations and writing operations on the security data. For example, when the current security mode 121 is the unauthenticated mode, reading operations and writing operations may not be permitted, thus avoiding unauthorized access to the security data. As such, the host device 20 (e.g., and/or a processor attempting to access the storage device 100 through the host device 20) may not be granted reading operations or writing operations when the current security mode 121 is the unauthenticated mode. The unauthenticated mode may be activated when the storage controller 110 has not received a command for processing security data from the host device 20 and/or when an authentication request from the host device 20 has been denied.

The authenticated mode may indicate that the security management module 120 has successfully completed an authentication procedure. For example, the authenticated mode may be activated when the storage controller 110 has received a command for processing security data from the host device 20 and an authentication request from the host device 20 has been approved. Here, the command for processing the security data may include an authentication request. In addition, the authentication request from the host device 20 may include an authentication request from the host device 20 and/or an authentication request from a trusted subject, such as a processor, attempting to access the storage device 100 through the host device 20. When the current security mode of the storage device 100 is the authenticated mode, the security manager 122 may approve a request for access to the security data, and may allow and perform a readding operation and a writing operation on the security data. In embodiments, the security mode 121 may initially be in the unauthenticated mode, and may remain in the unauthenticated mode until the authenticated mode (or another mode) is activated. For example, with the security mode 121 in the unauthenticated mode, the storage controller 110 may receive a command for processing security data from the host device 20 and may receive an authentication request from the host device 20. Approval of the authentication request by the security manager 122 may cause the security management module 120 to change the security mode 121 from the unauthenticated mode to the authenticated mode, thus granting access to a reading operation and a writing operation on the security data.

The zeroised mode may indicate that security data stored in the security memory device 124 and the security data buffer 126 have been initialized by the security management module 120. The zeroised mode may be activated when an initialization request has been sent by the host device 20 or it has been determined that initialization of security data is necessary within the system. When the current security mode of the storage device 100 is the zeroised mode, the security manager 122 may restrictively approve requests for access to security data. For example, the security manager 122 may provide initialized security data in response to a command for reading security data. In addition, the security manager 122 may block performing of writing operations on the security memory device 124 and the security data buffer 126 in response to a command for writing security data. In embodiments, in the zeroised mode, the security data stored in the security memory device 124 and the security data stored in the security data buffer 126 may be altered or overwritten with a fixed or meaningless value, such as, for example, a zero. As such, the zeroized mode may cause the security data stored in the security memory device 124 and the security data stored in the security data buffer 126 to be unrecoverable.

The debug mode may indicate that the storage device 100 is being debugged. The debug mode may be activated when a debugging port has been activated for the purpose of development, maintenance, etc. of the storage device 100. When the current security mode of the storage device 100 is the debug mode, the security manager 122 may restrictively approve requests for access to security data. For example, in the debug mode, the security manager 122 may initialize (e.g., zeroise) security data stored in the security data buffer 126 and allow only a reading operation on the security data buffer 126. That is, access to the security memory device 124 may be blocked in the debug mode. Accordingly, the security manager 122 may provide initialized security data stored in the security data buffer 126 in response to a command for reading the security data. In addition, the security manager 122 may block performing of writing operations on the security memory device 124 and the security data buffer 126 in response to a command for writing the security data.

The abnormal mode may indicate that the storage device 100 is in a fault state or a security threat has been detected. The abnormal mode may be activated when the storage device 100 is in a federal information processing standards (FIPS) certification failure state (FIPS Fail) or an abnormal operation of the device, such as detection of an attack or damage to the integrity of data, has been sensed. When the current security mode of the storage device 100 is the abnormal mode, the security manager 122 may initialize (e.g., zeroise) security data stored in the security memory device 124 and the security data buffer 126. In addition, the security manager 122 may block requests for access to the security data and operate to block a reading operation and a writing operation on the security data.

In one embodiment, the security memory device 124 may store at least some of the security data of the storage device 100. The security memory device 124 may be a dedicated memory area for storing and/or managing the security data of the storage device 100. The authority to access the security memory device 124 may be granted to the security manager 122 of the security management module 120. Accordingly, the security manager 122 may prevent the host device 20 and/or other components of the storage device 100 from directly accessing the security memory device 124 based on the current security mode of the storage device 100. In one embodiment, the security data of the storage device 100 may be stored entirely in the security memory device 124 included in the security management module 120. As a result, the storage and management of security data may be unified, and access to the security data may be efficiently controlled. This may ensure the integrity and confidentiality of the security data.

In one embodiment, the security memory device 124 may include a volatile memory device. The security memory device 124 may include a static random access memory (SRAM). In other embodiments, the security memory device 124 may include various volatile memory devices such as a dynamic random access memory (DRAM), a synchronous dynamic random access memory (SDRAM), and a resistance random access memory (RRAM). However, the present disclosure is not limited thereto, and the security memory device 124 may include a nonvolatile memory device. As a result, it may be possible for the security manager 122 to quickly respond to a request for access to security data on the security memory device 124 and efficiently perform a reading or writing operation on the security data.

In one embodiment, the security data buffer 126 may temporarily store a first security data read from the security memory device 124. Here, the first security data may include at least some of security data stored in the security memory device 124. As such, the security data buffer 126 may receive some of the security data (e.g., the first security data, which is a portion of the security data) from the security memory device 124 (e.g., by being read into the security data buffer 126 from the security memory device 124) and may temporarily hold or store this first security data. The authority to access the security data buffer 126 may be granted to the security manager 122 of the security management module 120. When performing a reading operation on security data, the security manager 122 may load the first security data from the security memory device 124 into the security data buffer 126 and then may read out the first security data stored in the security data buffer 126. As a result, direct access to the security memory device 124 may be restricted, and the possibility of the leakage of the security data may be effectively reduced. The security data buffer 126 may be, for example, a dynamic random access memory (DRAM), but the present disclosure is not limited thereto. As described herein, when performing a reading operation in which security data is read out, the security data may be retrieved or accessed from a storage device or location (e.g., security data buffer 126, etc.) without changing or altering the security data. In this way, in some embodiments, when the security data is read out, the storage location where the security data is stored may be determined, followed by transmission of a control signal to the storage location to start retrieval of the security data, followed by transfer of the security data from the storage location to another, different, location (e.g., the security data buffer 126, for example) and storage of the security data at the different location (e.g., the security data buffer 126, for example).

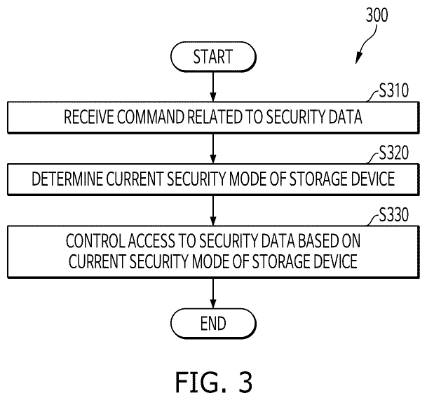

FIG. 3 is a flowchart for illustrating an example of a method 300 of operating a security management module according to some embodiments of the present disclosure. The method 300 of operating a security management module may be performed by a security manager of the security management module.

Referring to FIG. 3, the security manager of the security management module may receive a command related to security data at S310. For example, the security manager may receive a reading command, a writing command, etc. related to the security data from a storage controller (e.g., the storage controller 110 in FIGS. 1-2). The storage controller 110 may receive a request to read or write the security data from a host device (e.g., the host device 20 of FIG. 1), perform a separate authentication procedure, and then transmit a reading command or a writing command related to the security data to the security manager 122. For another example, the storage controller 110 may receive a request from the host device 20 to allocate a memory area where the security data will be stored, perform a separate authentication procedure, and then send a command related thereto to the security manager 122. For still another example, the security manager 122 may receive a reading command, a writing command, etc. related to the security data directly from the host device 20, although the present disclosure is not limited thereto.

In response to receiving a command related to the security data, the security manager 122 may determine the current security mode 121 of a storage device 100 at S320. In one embodiment, the security mode 121 may include an unauthenticated mode, an authenticated mode, a zeroised mode, a debug mode, and an abnormal mode, but the present disclosure is not limited thereto.

The security manager 122 may control access to the security data based on the current security mode 121 of the storage device at S330. In one embodiment, the security manager 122 may block access to the security data in response to determining that the current security mode is the unauthenticated mode. In one embodiment, the security manager 122 may allow access to the security data in response to determining that the current security mode is the authenticated mode. In one embodiment, the security manager 122 may allow limited access to the security data in response to determining that the current security mode is the zeroised mode. For example, in response to determining that the current security mode is the zeroised mode, the security manager 122 may allow performing of reading operations related to the security data and block performing of writing operations related to the security data. In one embodiment, in response to determining that the current security mode is the debug mode, the security manager 122 may allow limited access to the security data. For example, in response to determining that the current security mode is the debug mode, the security manager 122 may only allow reading operations on the security data buffer 126. In one embodiment, the security manager 122 may block access to the security data in response to determining that the current security mode is the abnormal mode. Accordingly, a plurality of security modes are possible, and may include a first security mode, a second security mode, and a third security mode. The first security mode may comprise the authenticated mode, in which the security manager 122 allows access to the security data, for example, by allowing reading operations and/or writing operations. The second security mode may be either the zeroised mode or the debug mode, and in the second mode, the security manager 122 allows limited access to the security data, for example, by allowing reading operations but blocking writing operations. As such, limited access of the second security mode is less access than in the first security mode, but more access than in the third security mode. The third security mode may be either the unauthenticated mode or the abnormal mode, and in the third security mode, the security manager 122 blocks access to the security data and may not allow reading operations or writing operations.

The flowchart and the description with reference to FIG. 3 are only exemplary, and may be constructed differently in some embodiments. For example, in some embodiments, the order of the steps may be changed, some steps may be performed repeatedly, some steps may be skipped, or some steps may be added.

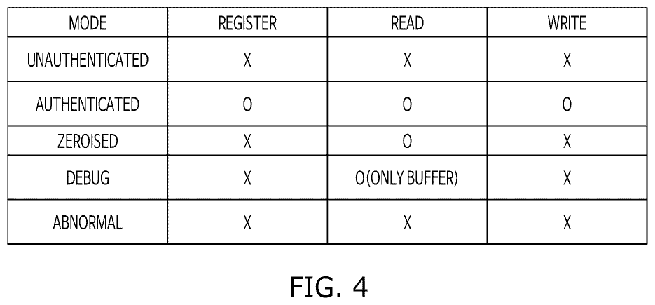

FIG. 4 shows security modes of a storage device 100 and what operation a security manager 122 is permitted to perform in each security mode according to one embodiment of the present disclosure. Referring to FIG. 4, the security modes of the storage device 100 may include an unauthenticated mode, an authenticated mode, a zeroised mode, a debug mode, and an abnormal mode.

In one embodiment, a registration operation may be a process of allocating a memory space for storing security data, and may refer to an operation of the security manager 122 registering an address of a memory where the security data will be stored in a management table and allocating a memory. A reading operation may refer to an operation of the security manager 122 loading the security data from a memory area where the security data has been stored (e.g., the security memory device 124) into a temporary storage space (e.g., the security data buffer 126) in order to read the security data and provide it to the subject that has requested it. A writing operation may refer to an operation of the security manager 122 writing the security data to a dedicated memory area (e.g., the security memory device 124) to write, modify, or update the security data.

In one embodiment, when the current security mode of the storage device 100 is the unauthenticated mode, the registration operation, the reading operation, and the writing operation, related to the security data, may be blocked. In one embodiment, when the current security mode of the storage device is the authenticated mode, the registration operation, the reading operation, and the writing operation, related to the security data, may be permitted. As a result, as only the trusted subject is allowed access, the confidentiality and integrity of the security data may be improved.

In one embodiment, when the current security mode of the storage device is the zeroised mode, the registration operation and the writing operation, related to the security data, may be blocked. In addition, when the current security mode of the storage device is the zeroised mode, the reading operation related to the security data may be permitted. In the zeroised mode, a memory area where the security data is stored has been initialized, so that, even when the reading operation is performed, initialized or invalidated data may be returned.

In one embodiment, when the current security mode of the storage device is the debug mode, the registration operation and the writing operation, related to the security data, may be blocked. In addition, when the current security mode of the storage device is the debug mode, the reading operation related to the security data may be permitted. Here, only access to a temporary storage space where the security data is stored, such as a security data buffer 126, may be permitted. In the debug mode, the security data buffer 126 may remain initialized, so that, even when the reading operation is performed, initialized or invalidated data may be returned. The debug mode may be a mode for supporting maintenance, development, analysis of defects, etc., and, in the mode, direct access to a security memory device 124 may be restricted. In the debug mode, only access to an initialized data buffer may be allowed, preventing leakage of sensitive security data through memory dumps.

In one embodiment, when the current security mode of the storage device 100 is the abnormal mode, the registration operation, the reading operation, and the writing operation, related to the security data, may be blocked. The abnormal mode may be activated when the storage device is in a federal information processing standards (FIPS) certification failure state (FIPS Fail) or an abnormal operation of the storage device, such as detection of an attack or damage to the integrity of data, has been sensed. As access to a memory area where the security data is stored may be blocked in the abnormal mode, leakage or misuse of sensitive security data may be prevented.

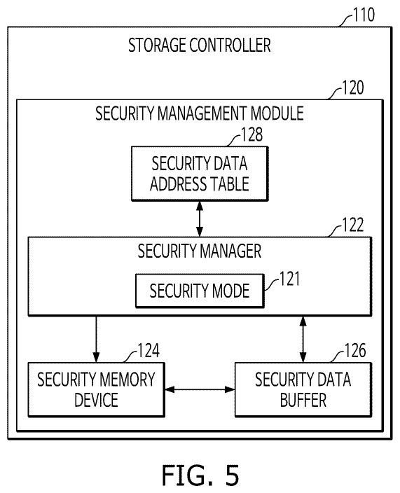

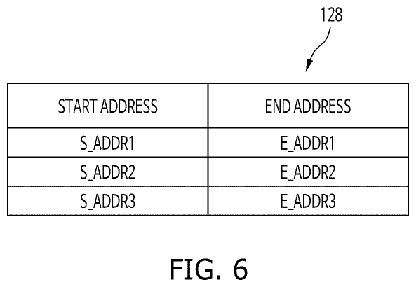

FIG. 5 is a block diagram for illustrating the storage controller 110 according to some embodiments of the present disclosure. FIG. 6 is a view for illustrating an example of a security data address table 128 according to one embodiment of the present disclosure. Hereinafter, descriptions that overlap with the foregoing descriptions will be skipped or summarized.

Referring to FIG. 5, the storage controller 110 may include the security management module 120 that manages security data of a storage device. The security management module 120 may include the security manager 122 that manages the security mode 121 of the storage device and controls access to the security data based on the current security mode of the storage device, the security memory device 124 that stores the security data, the security data buffer 126 that temporarily stores the security data read from the security memory device 124, and the security data address table 128 that stores address data related to the security data.

In one embodiment, the security data address table 128 may store a start address and an end address of the security data. When performing a registration operation, the security manager 122 may allocate a memory area for storing the security data and store a start address and an end address corresponding to the memory area in the security data address table 128. Here, the memory area for storing the security data may include a specific memory area within the security memory device 124. The security manager 122 may identify the memory area where the security data is stored by referring to the security data address table 128 and perform a reading operation or a writing operation on the area. As such, the security data address table 128 may store the location of the security data within the security memory device 124 FIG. 6 shows an example of the security data address table 128 according to one embodiment of the present disclosure. The security manager 122 may receive a first request for allocation of a memory space where security data is to be stored. When the security manager 122 determines that the current security mode of a storage device is the authenticated mode, the security manager 122 may allocate a first memory space in the security memory device 124 and store a first start address S_ADDR1 and a first end address E_ADDR1 corresponding to the first memory space in the security data address table 128. In addition, the security manager 122 may receive a second request for allocation of a memory space where the security data is to be stored, and, when determining that the current security mode of the storage device is the authenticated mode, the security manager 122 may allocate a second memory space within the security memory device 124 and store a second start address S_ADDR2 and a second end address E_ADDR2 corresponding to the second memory space in the security data address table 128. Further, the security manager 122 may receive a third request for allocation of a memory space where the security data is to be stored, and, when determining that the current security mode of the storage device is the authenticated mode, the security manager 122 may allocate a third memory space within the security memory device 124 and store a third start address S_ADDR3 and a third end address E_ADDR3 corresponding to the third memory space in the security data address table 128.

Although FIG. 6 shows the security data address table 128 where only start addresses and end addresses are stored, the present disclosure is not limited thereto. In one embodiment, the security data address table 128 may store at least two of a start address of security data, an end address of the security data, and the size of the security data. The security manager 122 may determine the range of a memory where security data is stored based on the information stored in the security data address table 128 and perform a reading operation or a writing operation on the security data. For example, the security manager 122 may determine a memory area where the security data is stored based on a start address and the size of the security data, or may determine the memory area where the security data is stored by referring to the start address and an end address of the security data. In addition, the security manager 122 may determine the memory area where the security data is stored based on the end address and the size of the security data.

In addition, the security data address table 128 may further store context information for identifying security data. When performing the registration operation, the security manager 122 may store context information corresponding to start and end addresses assigned to the subject requesting a command in the security data address table 128. When carrying out a reading operation or a writing operation on security data, the security manager 122 may extract a start address and an end address of the security data based on context information that has been requested and determine a memory area where the security data is stored based thereon.

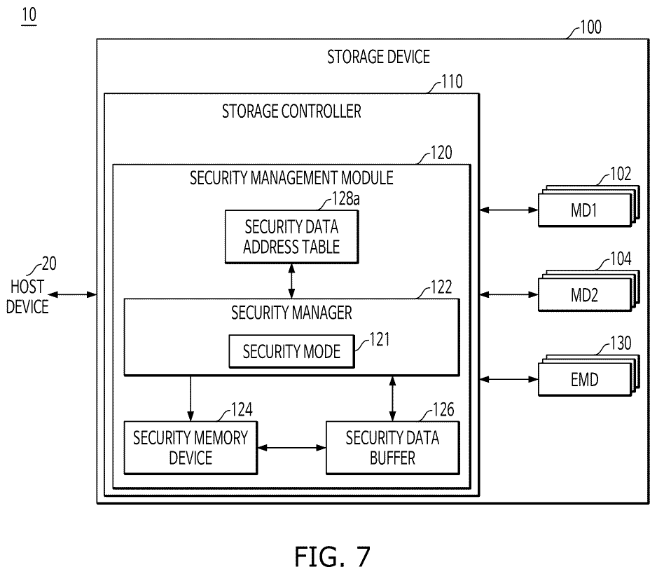

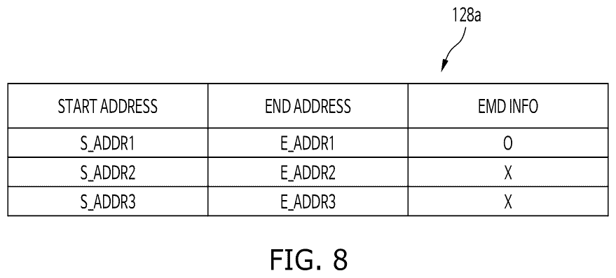

FIG. 7 is a block diagram for illustrating the storage device 100 according to some embodiments of the present disclosure. FIG. 8 is a view for illustrating an example of a security data address table 128a according to one embodiment of the present disclosure. Hereinafter, descriptions that overlap with the foregoing descriptions will be skipped or summarized. The security data address table 128a may correspond to the security data address table 128 in FIGS. 5 and 6.

The storage device 100 may include the storage controller 110, the first memory device 102, the second memory device 104, and an external memory device 130. The storage controller 110 may include the security management module 120, and the security management module 120 may include the security manager 122 that manages the security mode 121 of a storage device, the security memory device 124, the security data buffer 126, and the security data address table 128a.

The external memory device 130 may store some of security data and may be located outside the security management module 120. For example, the external memory device 130 may be separate from the security management module 120, and may be at a different location from the security memory device 124. The external memory device 130 may be a dedicated memory area for storing security data, which is separate from the security management module 120. The external memory device 130 may refer to a memory area for additionally storing or separately managing security data. Authority to access the external memory device 130 may be granted only to the security manager 122. The security manager 122 may prevent the host device 20 and/or other components of the storage device 100 from directly accessing the external memory device 130 based on the current security mode of the storage device 100. Security data stored in the external memory device 130 may be separate from security data stored in the security memory device 124 included in the security management module 120. As such, in some embodiments, the security memory device 124 may store a first portion of the security data, while the external memory device 130 may store a second portion of the security data, and the first portion of the security data may be different than the second portion of the security data. However, the present disclosure is not limited thereto, and at least some of the security data stored in the external memory device 130 may overlap with, or be the same as, at least some of the security data stored in the security memory device 124. In some embodiments, the security memory device 124 may not be included in the security management module 120, and all security data may be stored in the external memory device 130. For example, in some embodiments, the security management module 120 may not include a security memory device (e.g., security memory device 124), such that the security data may be stored in the external memory device 130.

In one embodiment, the external memory device 130 may include a one-time writable memory device such as a one-time programmable memory (OTP) or an electronic fuse (eFUSE). In other embodiments, the external memory device 130 may include at least one of a volatile memory device, such as a dynamic random access memory (DRAM) and a static random access memory (SRAM), and a nonvolatile memory device, such as a NAND flash, a NOR flash, an electrically erasable programmable read-only memory (EEPROM), a magnetic random access memory (MRAM), and a ferroelectric random access memory (FRAM).

In one embodiment, the security data buffer 126 may temporarily store a second security data read from the external memory device 130. For example, when the storage controller 110 includes the security memory device 124 and the external memory device 130, the security data buffer 126 may temporarily store the first security data that is read from the security memory device 124, and/or may temporarily store the second security data that is read from the external memory device 130. Here, the second security data may include at least some of security data stored in the external memory device 130. When performing a reading operation on the security data stored in the external memory device 130, the security manager 122 may load the second security data from the external memory device 130 into the security data buffer 126 and then read out the second security data stored in the security data buffer 126.

In one embodiment, the security data address table 128a may store a start address of security data, an end address thereof, and information on the external memory device (EMD INFO). Here, the information on the external memory device 130 may include information indicating that security data has been stored in the external memory device 130. For another example, the information on the external memory device 130 may include information indicating that the external memory device 130 has been allocated.

When performing a registration operation, the security manager 122 may allocate a memory area for storing security data and store a start address and an end address corresponding to the memory area in the security data address table 128a. Here, when the allocated memory area includes a specific memory area of the external memory device 130, the security manager 122 may store the information on the external memory device 130 in the security data address table 128a. When performing a writing operation, the security manager 122 may write security data to the external memory device 130 by referring to the security data address table 128a. In addition, when carrying out a reading operation, the security manager 122 may determine that security data has been stored in the external memory device 130 by referring to the security data address table 128a and perform the reading operation on the security data by accessing the external memory device 130 using the start address and the end address that are stored in the security data address table 128a. As such, the security data address table 128a may store information (e.g., start address, end address, size of the security data, etc.) related to the security data that is stored in the external memory device 130. In other embodiments, based on how the external memory device 130 stores data, only information on the external memory device 130 excluding a start address and an end address of the external memory device 130 may be stored in a row corresponding to security data stored in the external memory device 130 in the security data address table 128a.

FIG. 8 illustrates an example of the security data address table 128a according to one embodiment of the present disclosure. The security manager 122 may receive a first request for allocation of a memory space where security data is to be stored. The security manager 122 may determine whether to store the security data in the external memory device 130 based on the first request. Here, the first request may include a request to store the security data in the external memory device 130. However, the present disclosure is not limited thereto, and the security manager 122 may determine whether to store the security data in the external memory device 130 based on the properties, size, etc. of the security data included in the first request. When the current security mode of the storage device 100 is the authenticated mode and the external memory device 130 has been allocated, the security manager 122 may allocate a first memory space within the external memory device 130 and store a first start address S_ADDR1 and a first end address E_ADDR1, corresponding to the first memory space in the external memory device 130, and a first information on the external memory device 130 in the security data address table 128a. Thereafter, when the security manager 122 receives a request for subsequent writing or reading following the first request, it may determine whether to access the external memory device 130 based on the first information stored in the security data address table 128a, and may access the first memory space of the external memory device 130 based on the first start address S_ADDR1 and the first end address E_ADDR1 that are stored in the security data address table 128a.

In addition, the security manager 122 may receive a second request for allocation of a memory space where security data is to be stored, and may determine whether to store the security data in the external memory device 130 based on the second request. When the current security mode of the storage device 100 is the authenticated mode and the external memory device 130 has not been allocated, the security manager 122 may allocate a second memory space within the security memory device 124 and store a second start address S_ADDR2 and a second end address E_ADDR2, corresponding to the second memory space, and a second information indicating that the external memory device 130 has not been allocated in the security data address table 128a. For example, with reference to FIG. 8, the second row corresponds to the second memory space and includes the second start address S_ADDR2, the second end address E_ADDR2, and second information about the external memory device 130. As illustrated, the third column (“EMD info”) lists information about the external memory device 130, and in the second row corresponding to the second memory space, the “X” in the third column (“EMD info”) indicates that the external memory device 130 has not been allocated. In contrast, the “O” in the third column of the first row (e.g., corresponding to the first memory space with the first start address S_ADDR1 and a first end address E_ADDR1) indicates that the external memory device 130 has been allocated. With reference to the second memory space, when the security manager 122 receives a request for subsequent writing or reading following the second request, the security manager 122 may determine whether to access the security memory device 124 based on the second information and may access the second memory space of the security memory device 124 based on the second start address S_ADDR2 and the second end address E_ADDR2.

Furthermore, the security manager 122 may receive a third request for allocation of a memory space where security data is to be stored, and may determine whether to store the security data in the external memory device 130 based on the third request. When the current security mode of the storage device 100 is the authenticated mode and the external memory device 130 where the security data is to be stored has not been allocated, a third memory space within the security memory device 124 may be allocated, and a third start address S_ADDR3 and a third end address E_ADDR3, corresponding to the third memory space, and a third information indicating that the security data has not been stored in the external memory device 130 may be stored in the security data address table 128a. As illustrated in FIG. 8, the “X” in the third column (“EMD info”) of the third row (e.g., corresponding to the third memory space with the third start address S_ADDR3 and the third end address E_ADDR3) indicates that the external memory device 130 has not been allocated. Thereafter, when the security manager 122 receives a request for subsequent writing or reading following the third request, the security manager 122 may access the security memory device 124 based on the third information and may access the third memory space of the security memory device 124 based on the third start address S_ADDR3 and the third end address E_ADDR3.

FIG. 8 shows the security data address table 128a storing only start addresses and end addresses, but the present disclosure is not limited thereto. For example, the security data address table 128a may further store security data, context information for identifying the security data, size of the security data, etc.

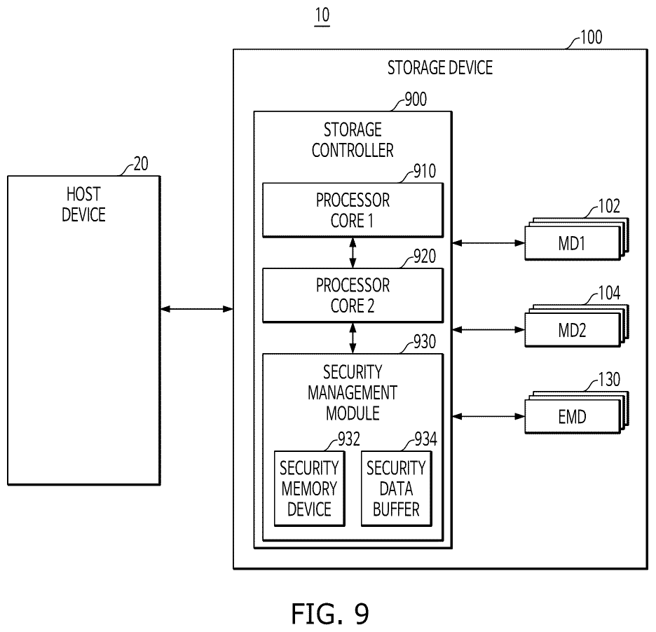

FIG. 9 is a block diagram illustrating the storage system 10 according to some embodiments of the present disclosure. Hereinafter, descriptions that overlap with the foregoing descriptions will be skipped or summarized. A storage controller 900 may correspond to the storage controller 110 in FIG. 1.

Referring to FIG. 9, the storage system 10 may include the host device 20 and the storage device 100 designed to exchange data with the host device 20. The storage device 100 may include the storage controller 900, the first memory device 102, the second memory device 104, and the external memory device 130. The storage controller 900 may include a first processor core 910, a second processor core 920, and a security management module 930 accessible only to the second processor core 920.

In one embodiment, the first processor core 910 may control the general operation of the storage device 100, process a request for reading and/or writing data, and manage the exchange of data with the host device 20. In addition, when a security-related operation is required, the first processor core 910 may request the second processor core 920 to perform the operation, and may carry out subsequent operations based on a response received from the second processor core 920. Accordingly, the first processor core 910 may control non-security-related operations, for example, requests for reading and/or writing data, and management of the exchange of data with the host device 20, while the second processor core 920 may control security-related operations. However, the present disclosure is not limited thereto, and the second processor core 920 may receive a security-related request or command directly from the host device 20.

In one embodiment, the second processor core 920 may control security-related operations of the storage device 100 and may exclusively access the security management module 930 and the external memory device 130 to manage security data. For example, the second processor core 920 may generate an encryption key based on data received from the host device 20 or perform an authentication procedure related to an external component, e.g., the host device 20. For another example, the second processor core 920 may manage the security mode of the storage device 100 and control access to the security management module 930 and the external memory device 130 based on the current security mode of the storage device 100.

In one embodiment, the above-described operations performed by a security manager, e.g., the security manager 122 in FIG. 1, may be performed by the second processor core 920. In addition, the operations performed by the security manager, which will be described below, may be carried out by the second processor core 920. In one embodiment, the second processor core 920 may receive a command related to security data, determine the current security mode of the storage device 100 in response to receiving the command related to the security data, and control access to the security management module 930 based on the current security mode. For example, the second processor core 920 may access a security memory device 932 or a security data buffer 934 where the security data has been stored based on the current security mode of the storage device 100 to read out the security data, write the security data to the security memory device 932, etc.

In one embodiment, the second processor core 920 may block an operation on the security memory device 932 in response to determining that the current security mode of the storage device 100 is the unauthenticated mode.

The second processor core 920 may manage the security mode of the storage device 100. In one embodiment, the second processor core 920 may determine whether to approve an authentication request from the host device 20. For example, the second processor core 920 may determine whether the subject attempting to access the storage device 100 through the host device 20 is reliable, and may switch the current security mode of the storage device 100 to the authenticated mode when the authentication request has been approved. The second processor core 920 may allow performing of at least one of a reading operation and a writing operation on the security memory device 932 in response to determining that the current security mode of the storage device 100 is the authenticated mode.

In one embodiment, the second processor core 920 may receive a signal related to the state of the storage device 100 from the first processor core 910 and switch the security mode of the storage device 100 based on the received signal. In one embodiment, the second processor core 920 may monitor the state of the storage device 100 and switch the security mode of the storage device 100.

In one embodiment, the first processor core 910 may transmit an initialization signal to the second processor core 920 in response to an initialization request from the host device 20, and the second processor core 920 may switch the security mode of the storage device 100 to the zeroised mode in response to receiving the initialization signal. The second processor core 920 may initialize (e.g., zeroise) security data stored in each of the security memory device 932 and the security data buffer 934 in response to determining that the current security mode of the storage device 100 is the zeroised mode.

In one embodiment, the first processor core 910 may monitor the debugging status of the storage device 100 and transmit a debug signal to the second processor core 920 based on the current debugging status. However, the present disclosure is not limited thereto, and the second processor core 920 may also monitor the debugging status of the storage device 100. The second processor core 920 may switch the current security mode of the storage device 100 to the debug mode in response to receiving the debug signal. The second processor core 920 may initialize security data stored in the security data buffer 934 in response to determining that the current security mode of the storage device 100 is the debug mode.

In one embodiment, the first processor core 910 may monitor whether the storage device 100 is in an abnormal state and transmit an abnormal state signal to the second processor core 920 based on a determination that the storage device 100 is in the abnormal state. However, the present disclosure is not limited thereto, and the second processor core 920 may also monitor whether the storage device 100 is in an abnormal state. The second processor core 920 may switch the current security mode of the storage device 100 to the abnormal mode in response to receiving the abnormal state signal. The second processor core 920 may initialize security data stored in each of the security memory device 932 and the security data buffer 934 in response to determining that the current security mode of the storage device 100 is the abnormal mode.

In addition, in response to receiving a command related to security data, the second processor core 920 may perform operations of registering an address of a memory for storing the security data in a management table, processing allocation of a memory, etc.

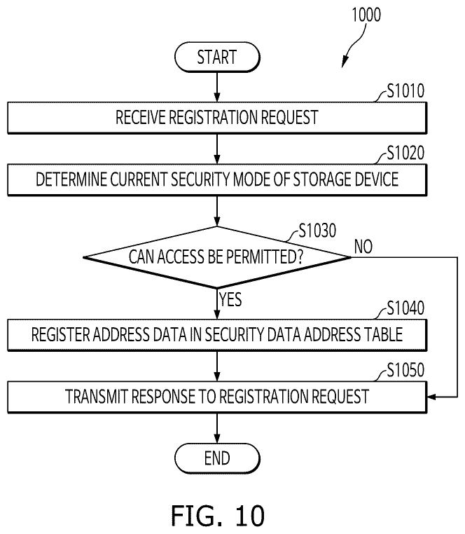

FIG. 10 is a flowchart for illustrating an example of a method 1000 of performing a registration operation related to security data according to some embodiments of the present disclosure. In some embodiments, the method 1000 of performing a registration operation related to security data may be carried out by a security manager of a security management module, e.g., the security manager 122 in FIG. 1. In some embodiments, the method 1000 of performing a registration operation related to security data may be carried out by a second processor core of a storage controller, e.g. the second processor core 920 in FIG. 9. In the following description, the method 1000 of performing a registration operation related to security data is carried out by a security manager, but a second processor core may also perform the method 1000 of performing a registration operation related to security data in a similar manner.

Referring to FIG. 10, a security manager of a security management module may receive a registration request related to security data at S1010. For example, the security manager may receive the registration request related to security data from a storage controller. For another example, the security manager may receive the registration request related to security data from a host device 20. Here, the registration request may include a request for allocation of a memory space where the security data is to be stored. In one embodiment, the memory space where the security data is to be stored may include at least one of a security memory device (e.g., the security memory device 932) and an external memory device (e.g., the external memory device 130).

In response to receiving the registration request related to security data, the security manager may determine the current security mode of a storage device at S1020. In one embodiment, the security modes of the storage device may include an unauthenticated mode, an authenticated mode, a zeroised mode, a debug mode, and an abnormal mode, but the present disclosure is not limited thereto. One or more of the above-mentioned security modes may be excluded, or one or more additional security modes may be included.

The security manager may determine whether access to the security management module (e.g., the security management module 930) is permitted at the registration request based on the current security mode of the storage device at S1030. In one embodiment, when determining that the current security mode of the storage device is one of the unauthenticated mode, the zeroised mode, the debug mode, and the abnormal mode, the security manager may determine that access to the security management module is not permitted. In one embodiment, when determining that the current security mode of the storage device is the authenticated mode, the security manager may determine that access to the security management module is permitted.

When determining that access to the security management module 930 is not permitted after receiving the registration request, the security manager may transmit a response to the registration request at S1050. For example, the response to the registration request may include a signal indicating that access to the security management module is not permitted, but the present disclosure is not limited thereto.

When determining that access to the security management module 930 is permitted at the registration request, the security manager may allocate a memory space where security data is to be stored and register a start address and an end address in a security data address table at S1040. In one embodiment, when the allocated memory space is a specific memory area within an external memory device 130, the security manager may register information on the external memory device 130 in the security data address table (e.g., illustrated in FIG. 8). Here, the information on the external memory device 130 may include information indicating that security data has been stored in the external memory device 130. For another example, the information on the external memory device 130 may include information indicating that the external memory device 130 has been allocated. Thereafter, the security manager may transmit a response to the registration request at S1050. For example, the response to the registration request may include a signal indicating that allocation of a memory space where security data is to be stored has been completed, but the present disclosure is not limited thereto.

The flowchart and the description with reference to FIG. 10 are only exemplary, and may be constructed differently in some embodiments. For example, in some embodiments, the order of the steps may be changed, some steps may be performed repeatedly, some steps may be skipped, or some steps may be added.

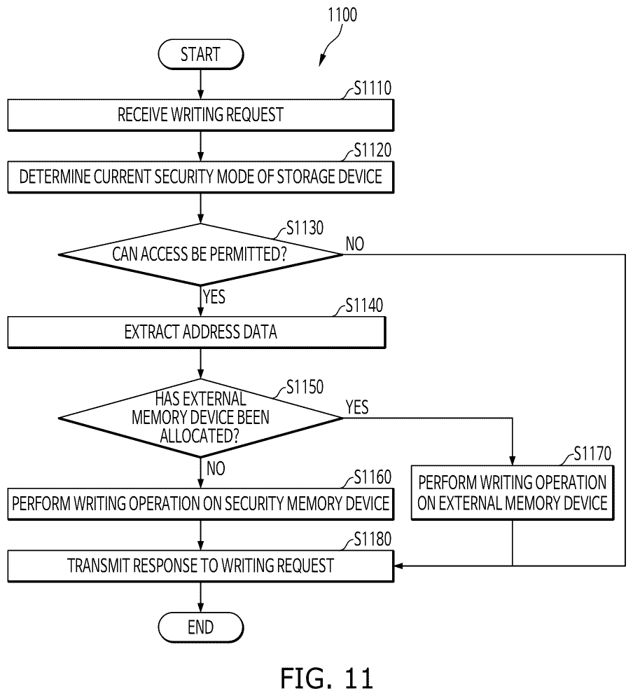

FIG. 11 is a flowchart illustrating an example of a method 1100 of performing a writing operation related to security data according to some embodiments of the present disclosure. In some embodiments, the method 1100 of performing a writing operation related to security data may be performed by a security manager of a security management module, e.g., the security manager 122 in FIG. 1. In some embodiments, the method 1100 of performing a writing operation related to security data may be carried out by a second processor core of a storage controller, e.g. the second processor core 920 in FIG. 9. In the following description, the method 1100 of performing a writing operation related to security data is carried out by a security manager, but a second processor core 920 may also perform the method 1100 of performing a writing operation related to security data in a similar manner.

Referring to FIG. 11, a security manager of a security management module may receive a writing request related to security data at S1110. For example, the security manager may receive the writing request related to security data from a storage controller. For another example, the security manager may receive the writing request related to security data from a host device 20.

In response to receiving the writing request related to security data, the security manager may determine the current security mode of a storage device 100 at S1120. In one embodiment, the security modes of the storage device may include an unauthenticated mode, an authenticated mode, a zeroised mode, a debug mode, and an abnormal mode, but the present disclosure is not limited thereto. One or more of the above-mentioned security modes may be excluded, or one or more additional security modes may be included.

The security manager may determine whether access to the security management module 930 is permitted at the writing request based on the current security mode of the storage device 100 at S1130. In one embodiment, when determining that the current security mode of the storage device 100 is one of the unauthenticated mode, the zeroised mode, the debug mode, and the abnormal mode, the security manager may determine that access to the security management module is not permitted. In one embodiment, when determining that the current security mode of the storage device is the authenticated mode, the security manager may determine that access to the security management module is permitted.

When determining that access to the security management module is not permitted at the writing request, the security manager may transmit a response to the writing request at S1180. For example, the response to the writing request may include a signal indicating that access to the security management module is not permitted, but the present disclosure is not limited thereto.

Referring still to S1130, when determining that access to the security management module is permitted at the writing request, the security manager may extract an address data from a security data address table (e.g., illustrated in FIG. 8) at S1140. In one embodiment, the address data may include a memory space allocated to store security data or a start address and an end address of a memory space where the security data has been stored. In one embodiment, the address data may further include information indicating that an external memory device 130 has been allocated to store security data or that the external memory device 130 has stored the security data.

The security manager may determine whether the external memory device 130 has been allocated to store security data based on the extracted address data at S1150. In other embodiments, the security manager may determine whether the security data has been stored in the external memory device 130 based on the extracted address data. When determining that the external memory device 130 has not been allocated, the security manager may perform a writing operation on a security memory device 932 based on the extracted address data at S1160, and may not perform a writing operation on the external memory device 130. As such, the writing operation (e.g., for performing the writing operation on either the security memory device 932 or the external memory device 130) may be based on a determination of whether the external memory device 130 has been allocated, and if the external memory device 130 has not been allocated, then the writing operation is performed on the security memory device 932. Thereafter, the security manager may transmit a response to the writing request at S1180. For example, the response to the writing request may include a signal that a writing operation has been completed, but the present disclosure is not limited thereto.

When determining that an external memory device 130 has been allocated, the security manager may perform a writing operation on the external memory device 130 based on the extracted address data at S1170. Then, the security manager may transmit a response to the writing request at S1180. For example, the response to the writing request may include a signal that the writing operation has been completed, but the present disclosure is not limited thereto.

The flowchart and the description with reference to FIG. 11 are only exemplary, and may be constructed differently in some embodiments. For example, in some embodiments, the order of the steps may be changed, some steps may be performed repeatedly, some steps may be skipped, or some steps may be added.

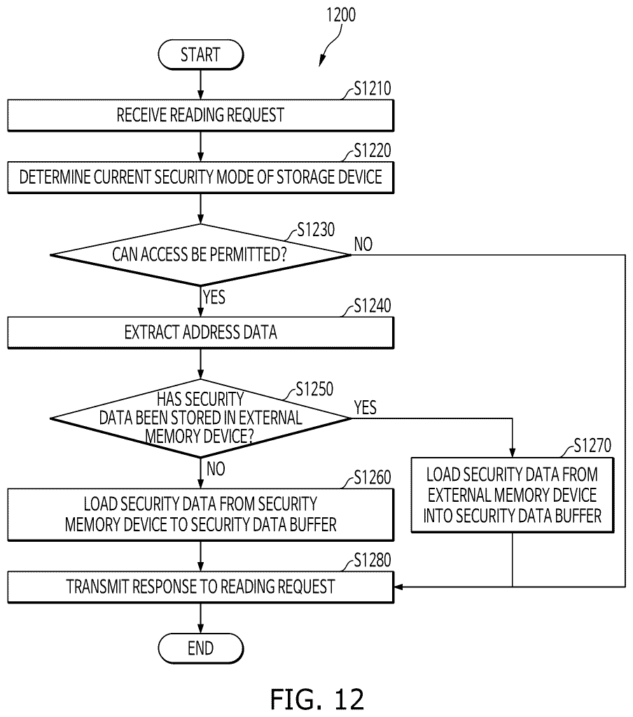

FIG. 12 is a flowchart illustrating an example of a method 1200 of performing a reading operation related to security data according to some embodiments of the present disclosure. In some embodiments, the method 1200 of performing a reading operation related to security data may be performed by a security manager of a security management module, e.g., the security manager 122 in FIG. 1. In some embodiments, the method 1200 of performing a reading operation related to security data may be carried out by a second processor core of a storage controller, e.g. the second processor core 920 in FIG. 9. In the following description, the method 1200 of performing a reading operation related to security data is carried out by a security manager, but a second processor core 920 may also perform the method 1200 of performing a reading operation related to security data in a similar manner.

Referring to FIG. 12, a security manager of a security management module may receive a reading request related to security data at S1210. For example, the security manager may receive the reading request related to security data from the storage controller. For another example, the security manager may receive the reading request related to security data from a host device 20.

In response to receiving the reading request related to security data, the security manager may determine the current security mode of a storage device 100 at S1220. In one embodiment, the security modes of the storage device may include an unauthenticated mode, an authenticated mode, a zeroised mode, a debug mode, and an abnormal mode, but the present disclosure is not limited thereto. One or more of the above-mentioned security modes may be excluded, or one or more additional security modes may be included.

The security manager may determine whether access to the security management module 930 is permitted at the reading request based on the current security mode of the storage device 100 at S1230. In one embodiment, when determining that the current security mode of the storage device is either the unauthenticated mode or the abnormal mode, the security manager may determine that access to the security management module is not permitted. In one embodiment, when determining that the current security mode of the storage device is one of the authenticated mode, the zeroised mode, and the debug mode, the security manager may determine that access to the security management module is permitted.

When determining that access to the security management module is not permitted at the reading request, the security manager may transmit a response to the reading request at S1280. For example, the response to the reading request may include a signal indicating that access to the security management module is not permitted, but the present disclosure is not limited thereto.

Referring still to S1230, when determining that access to the security management module is permitted at the reading request, the security manager may extract an address data from a security data address table (e.g., illustrated in FIG. 8) at S1240. In one embodiment, the address data may include a start address and an end address of a memory space where security data has been stored. In one embodiment, the address data may further include information indicating that an external memory device 130 has stored the security data.

The security manager may determine whether security data has been stored in the external memory device 130 based on the extracted address data at S1250. When determining that the security data has not been stored in the external memory device 130, the security manager may load the security data from a security memory device 932 to a security data buffer 934 at S1260. The security manager may read out the security data loaded into the security data buffer 934. Then, the security manager may transmit a response to the reading request at S1280. For example, the response to the reading request may include at least one of security data that has been read out and a signal that a reading operation has been completed, but the present disclosure is not limited thereto. In one embodiment, the security data that has been read out may be transmitted to the host device 20 after undergoing a separate decryption process.

In one embodiment, when the current security mode of the storage device is the debug mode, the security manager may not access the security memory device 932 but, instead, may access the security data buffer 934. In the debug mode, the security data buffer 934 may remain initialized, so the security manager may read out initialized or invalidated data when performing a reading operation on the security data buffer 934.

Referring still to S1250, when determining that security data has been stored in the external memory device 130, the security manager may load the security data from the external memory device 130 into the security data buffer 934 at S1270. The security manager may read out the security data loaded into the security data buffer 934. Then, the security manager may transmit a response to a reading request. For example, the response to the reading request may include at least one of the security data that has been read out and a signal that a reading operation has been completed, but the present disclosure is not limited thereto. In one embodiment, the security data that has been read out may be transmitted to the host device 20 after a separate decryption process by the storage controller. Accordingly, the reading operation may be based on a determination of whether the security data has been stored in the external memory device 130, and if the security data has not been stored in the external memory device 130, then the reading operation is performed on the security data that is stored in the security memory device 932.

The flowchart and the description with reference to FIG. 12 are only exemplary, and may be constructed differently in some embodiments. For example, in some embodiments, the order of the steps may be changed, some steps may be performed repeatedly, some steps may be skipped, or some steps may be added.

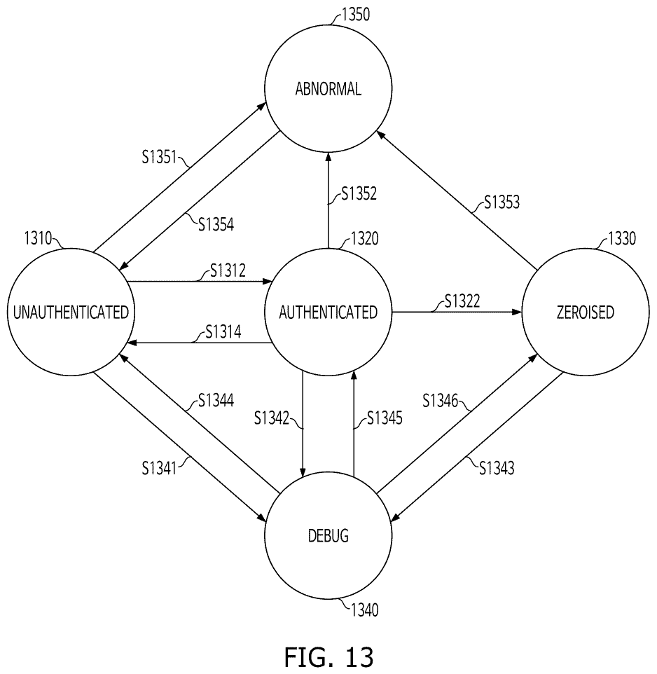

FIG. 13 illustrates an example of how a security mode of a storage device is switched according to some embodiments of the present disclosure. Referring to FIG. 13, the security modes of the storage device may include an unauthenticated mode 1310, an authenticated mode 1320, a zeroised mode 1330, a debug mode 1340, and an abnormal mode 1350.

Referring to FIG. 13, the security mode of the storage device may be switched from the unauthenticated mode 1310 to one of the authenticated mode 1320, the debug mode 1340, and the abnormal mode 1350 at S1312, S1341, and S1351. The unauthenticated mode 1310 may indicate that authentication by a security management module has not been performed. The unauthenticated mode 1310 may be activated as a default mode in a normal state where the storage device is initialized or an authentication procedure has not been carried out

At S1312, the security mode of the storage device may be switched from the unauthenticated mode 1310 to the authenticated mode 1320 when an authentication procedure has been successfully completed for the subject who transmitted a command related to security data. For example, to switch from the unauthenticated mode 1310 to the authenticated mode 1320, a subject may initially transmit a command, wherein the subject may be a host device 20, etc. The storage controller may receive the command from the subject, and based on receiving the command, the storage controller may compare hash values of a digital signature or authentication token using an encryption/decryption engine or may perform the authentication procedure using a symmetric key or an asymmetric key. The security mode of the storage device 100 may then be switched from the unauthenticated mode 1310 to the authenticated mode 1320. However, the present disclosure is not limited thereto, and the authentication procedure may be performed in various ways.

In one embodiment, the storage controller may verify whether the host device 20 or the subject attempting to access the storage device through the host device 20 can be trusted in response to receiving a command related to security data from the host device 20. When the storage controller has approved the authentication, the storage controller may send a signal that the authentication has been approved to the security management module. In response to receiving the signal that the authentication has been approved, a security manager may switch the current security mode of the storage device from the unauthenticated mode 1310 to the authenticated mode 1320.

The security mode of the storage device 100 may be switched from the authenticated mode 1320 to the unauthenticated mode 1310 when an operation related to security data has been completed at S1314. For example, when the security manager has allocated a memory area for storing security data, completed an operation of writing security data into an allocated memory area, or completed an operation of reading security data stored in a memory area, the security mode of the storage device 100 may be switched from the authenticated mode 1320 to the unauthenticated mode 1310.

In other embodiments, at S1314, the security mode of the storage device may be switched from the authenticated mode 1320 to the unauthenticated mode 1310 when a series of operations related to security data have been completed according to a session-based approach. For example, when the security manager allocates a memory area for storing security data and immediately performs an operation of writing the security data into the memory area during a specific session, the security mode of the storage device may be switched from the authenticated mode 1320 to the unauthenticated mode 1310 as the session ends and after the operation of writing the security data into the memory area has been completed. However, the present disclosure is not limited thereto.

In one embodiment, the security manager may switch the current security mode of the storage device from the authenticated mode 1320 to the unauthenticated mode 1310 in response to completing at least one of a reading operation and a writing operation on at least one of a security memory device (e.g., security memory device 124 or 932) and an external memory device 130. In one embodiment, the security manager may switch the current security mode of the storage device from the authenticated mode 1320 to the unauthenticated mode 1310 in response to completing an operation of allocating a memory area for storing security data and storing a start address and an end address corresponding to the memory area in a security data address table (e.g., illustrated in FIG. 8).

The security mode of the storage device may be switched from the authenticated mode 1320 to the zeroised mode 1330 when an authenticated subject or host device 20 has sent a command for initializing security data at S1322. For example, when the storage controller has received an initialization command from an authenticated subject, the security mode of the storage device may be switched from the authenticated mode 1320 to the zeroised mode 1330. However, the present disclosure is not limited thereto.

In one embodiment, the storage controller may receive a command for initializing security data from the host device 20. In response to receiving the initialization command from the host device 20, the storage controller may verify whether the host device 20 can be trusted. The storage controller may transmit an initialization signal to the security management module when the authentication request from the host device 20 has been approved. In response to receiving the initialization signal, the security manager may switch the current security mode of the storage device from the authenticated mode 1320 to the zeroised mode 1330. In one embodiment, the security manager may initialize or invalidate data (e.g., zeroise the data) stored in the security memory device, a security data buffer, the security data address table, and the external memory device when having switched the current security mode of the storage device to the zeroised mode 1330.

The security mode of the storage device may be switched from any one of the unauthenticated mode 1310, the authenticated mode 1320, and the zeroised mode 1330 to the debug mode 1340 when the storage device is being debugged at S1341, S1342, and S1343. For example, when the storage controller receives a specific debugging command when a debugging port has been activated or the vendor unique unlock state (VU Unlock) has been identified, the security mode of the storage device may be switched from any one of the unauthenticated mode 1310, the authenticated mode 1320, and the zeroised mode 1330 to the debug mode 1340. For another example, the security mode of the storage device may also be switched to the debug mode 1340 when an authentication procedure for debugging has been performed at the manufacturer's request for debugging or a specific authentication key or token for starting a debugging session has been verified. However, the present disclosure is not limited thereto, and the security mode of the storage device may be switched to the debug mode 1340 under various conditions.

In one embodiment, the storage controller may monitor how the storage device is being debugged and send a debugging signal to the security management module based on the monitoring result. In response to receiving the debugging signal, the security manager may switch the current security mode of the storage device to the debug mode 1340. In one embodiment, the security manager may initialize or invalidate security data stored in the security data buffer when switching the current security mode of the storage device to the debug mode 1340.

The security mode of the storage device may be switched from the debug mode 1340 to the original security mode among the unauthenticated mode 1310, the authenticated mode 1320, and the zeroised mode 1330 when the storage device is no longer being debugged at S1344, S1345, and S1346. For example, when the debugging port has been inactivated or the debugging authentication key or token has been expired after the termination of the debugging session, the security mode of the storage device may be switched from the debug mode 1340 to the original security mode. The original security mode is the security mode of the storage device immediately prior to the security mode being switched to the debug mode 1340. As such, if the security mode of the storage device was initially in the unauthenticated mode 1310 prior to being switched to the debug mode 1340 at S1341, then the original security mode is the unauthenticated mode 1310, and the security mode of the storage device may be switched back from the debug mode 1340 to the unauthenticated mode 1310 at S1344 when the storage device is no longer being debugged. Likewise, if the security mode of the storage device was initially in the authenticated mode 1320 prior to being switched to the debug mode 1340 at S1342, then the original security mode is the authenticated mode 1320, and the security mode of the storage device may be switched back from the debug mode 1340 to the authenticated mode 1320 at S1345 when the storage device is no longer being debugged. Similarly, if the security mode of the storage device was initially in the zeroised mode 1330 prior to being switched to the debug mode 1340 at S1343, then the original security mode is the zeroised mode 1330, and the security mode of the storage device may be switched back from the debug mode 1340 to the zeroised mode 1330 at S1346 when the storage device is no longer being debugged. For another example, the security mode of the storage device may also be switched from the debug mode 1340 to the original security mode when the debugging request has been withdrawn after the completion of the manufacturer's debugging work. However, the present disclosure is not limited thereto, and the security mode of the storage device may be switched from the debug mode 1340 to the original security mode under various conditions.

In one embodiment, the storage controller may monitor how the storage device is being debugged and send a signal that the debugging has ended to the security management module based on the monitoring result. In response to receiving the signal that the debugging has ended, the security manager may switch the current security mode of the storage device to the original security mode prior to switching to the debug mode 1340.

The security mode of the storage device may be switched from one of the unauthenticated mode 1310, the authenticated mode 1320, and the zeroised mode 1330 to the abnormal mode 1350 when the storage device is in a fault state or a security threat has been detected at S1351, S1352, and S1353. For example, when the storage controller has detected a physical or logical error in the storage device itself and thus cannot continue a normal operation (device fail) or authentication has failed because the authentication requirements according to the federal information processing standards (FIPS) are not met (FIPS fail), the security mode of the storage device may be switched from any one of the unauthenticated mode 1310, the authenticated mode 1320, and the zeroised mode 1330 to the abnormal mode 1350. In addition, when an abnormal operation from the outside has been detected, for example, when an exceptional situation that a CPU cannot handle has occurred (CPU Exception) or a fault injection attack on a memory or computational device has been detected, the security mode of the storage device may be switched to the abnormal mode 1350. Furthermore, the security mode of the storage device may also be switched to the abnormal mode 1350 when a crypto hardware fail has been detected or an unexpected situation such as damage to data integrity has occurred. However, the present disclosure is not limited thereto, and the security mode of the storage device may be switched to the abnormal mode 1350 under various conditions.

In one embodiment, the storage controller may monitor whether the storage device is in an abnormal state and transmit a signal indicating that the storage device is in an abnormal state to the security management module based on a determination that the storage device is in an abnormal state. In response to receiving the signal, the security manager may switch the current security mode of the storage device from one of the unauthenticated mode 1310, the authenticated mode 1320, and the zeroised mode 1330 to the abnormal mode 1350. In one embodiment, the security manager may initialize or invalidate data stored in the security memory device, the security data buffer, and the security data address table when the current security mode of the storage device has been switched to the abnormal mode 1350.

The security mode of the storage device may be switched from the abnormal mode 1350 to the unauthenticated mode 1310 when the storage device has been restored to a normal state at S1354. For example, when the storage device has been restored to a normal state through a power cycle or a device format has been performed on the storage device, the security mode of the storage device may be switched from the abnormal mode 1350 to the unauthenticated mode 1310. However, the present disclosure is not limited thereto, and the security mode of the storage device is switched from the abnormal mode 1350 to the unauthenticated mode 1310 under various conditions.

In one embodiment, the storage controller may monitor whether the storage device has recovered to a normal state and transmit a signal that the storage device has recovered to a normal state to the security management module based on a determination that the storage device has recovered to a normal state. In response to receiving the signal that the storage device has recovered to a normal state, the security manager may switch the current security mode of the storage device from the abnormal mode 1350 to the unauthenticated mode 1310.

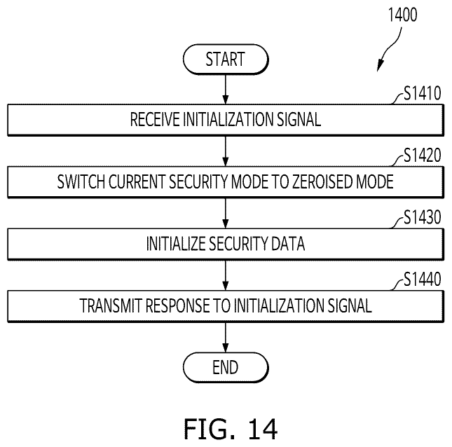

FIG. 14 is a flowchart for illustrating an example of a method 1400 of switching a security mode according to some embodiments of the present disclosure. In some embodiments, the method 1400 of switching a security mode may be carried out by a security manager of a security management module, e.g., the security manager 122 in FIG. 1. In some embodiments, the method 1400 of switching a security mode may be carried out by a second processor core of a storage controller, e.g. the second processor core 920 in FIG. 9. In the following description, the method 1400 of switching a security mode is carried out by a security manager, but a second processor core 920 may also perform the method 1400 of switching a security mode in a similar manner.

Referring to FIG. 14, a security manager of a security management module may receive an initialization signal at S1410. For example, the security manager may receive the initialization signal from a storage controller. The storage controller may verify whether a host device 20 or the subject accessing through the host device 20 can be trusted in response to receiving an initialization command from the host device 20. The storage controller may send the initialization signal to the security management module when an authentication request from the host device 20 has been approved.

The security manager may switch the current security mode of a storage device to the zeroised mode in response to receiving the initialization signal at S1420. In one embodiment, the security manager may switch the current security mode of the storage device from the authenticated mode to the zeroised mode in response to receiving the initialization signal.

After switching the current security mode of the storage device to the zeroised mode, the security manager may initialize or invalidate (e.g., zeroise) data stored in a security memory device, a security data buffer, a security data address table, and an external memory device at S1430. Then, the security manager may transmit a response to the initialization signal at S1440. For example, the response to the initialization signal may include a signal indicating that initializing of security data has been completed, but the present disclosure is not limited thereto.

The flowchart and the description with reference to FIG. 14 are only exemplary, and may be constructed differently in some embodiments. For example, in some embodiments, the order of the steps may be changed, some steps may be performed repeatedly, some steps may be skipped, or some steps may be added.

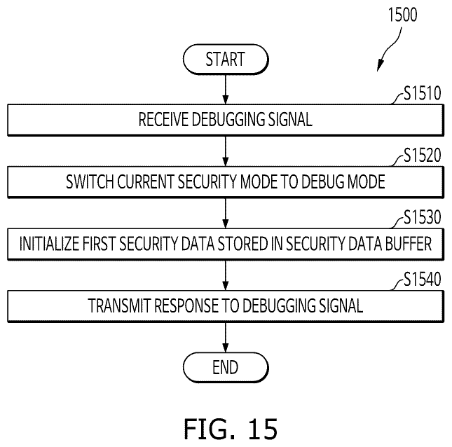

FIG. 15 is a flowchart for illustrating an example of a method 1500 of switching a security mode according to some embodiments of the present disclosure. In some embodiments, the method 1500 of switching a security mode may be carried out by a security manager of a security management module, e.g., the security manager 122 in FIG. 1. In some embodiments, the method 1500 of switching a security mode may be carried out by a second processor core of a storage controller, e.g. the second processor core 920 in FIG. 9. In the following description, the method 1500 of switching a security mode is carried out by a security manager, but a second processor core 920 may also perform the method 1500 of switching a security mode in a similar manner.

Referring to FIG. 15, a security manager of a security management module may receive a debugging signal at S1510. For example, the security manager may receive the debugging signal from a storage controller. The storage controller may monitor how a storage device is being debugged and send the debugging signal to the security management module based on the monitoring result.

The security manager may switch the current security mode of the storage device to the debug mode in response to receiving the debugging signal at S1520. In one embodiment, the security manager may switch the current security mode of the storage device from one of the unauthenticated mode, the authenticated mode, and the zeroised mode to the debug mode in response to receiving the debugging signal.

After switching the current security mode of the storage device to the debug mode, the security manager may initialize or invalidate data stored in a security data buffer at S1530. Then, the security manager may transmit a response to the debugging signal at S1540. For example, the response to the debugging signal may include a signal indicating that initializing of the security data buffer has been completed, but the present disclosure is not limited thereto.

In addition, the security manager may receive a signal that the debugging has ended from the storage controller and switch the current security mode of the storage device to a mode (e.g., the original security mode described herein) prior to switching to the debug mode in response thereto. The storage controller may monitor how the storage device is being debugged and send the signal that the debugging has ended to the security management module based on the monitoring result.

The flowchart and the description with reference to FIG. 15 are only exemplary, and may be constructed differently in some embodiments. For example, in some embodiments, the order of the steps may be changed, some steps may be performed repeatedly, some steps may be skipped, or some steps may be added.

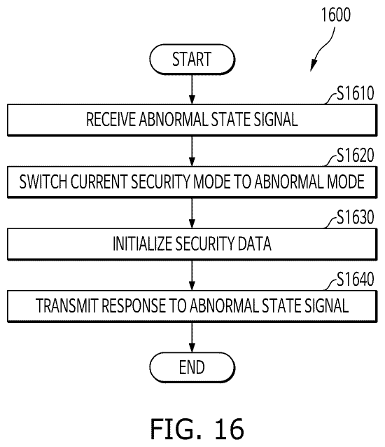

FIG. 16 is a flowchart for illustrating an example of a method 1600 of switching a security mode according to some embodiments of the present disclosure. In some embodiments, the method 1600 of switching a security mode may be carried out by a security manager of a security management module, e.g., the security manager 122 in FIG. 1. In some embodiments, the method 1600 of switching a security mode may be carried out by a second processor core of a storage controller, e.g. the second processor core 920 in FIG. 9. In the following description, the method 1600 of switching a security mode is carried out by a security manager, but a second processor core 920 may also perform the method 1600 of switching a security mode in a similar manner.

Referring to FIG. 16, a security manager of a security management module may receive an abnormal state signal at S1610. For example, the security manager may receive the abnormal state signal from a storage controller. The storage controller may monitor whether a storage device is in an abnormal state, and send the abnormal state signal indicating that the storage device is in an abnormal state to the security management module based on a determination that the storage device is in an abnormal state.

The security manager may switch the current security mode of the storage device to the abnormal mode in response to receiving the abnormal state signal at S1620. In one embodiment, the security manager may switch the current security mode of the storage device from one of the unauthenticated mode, the authenticated mode, and the zeroised mode to the abnormal mode in response to receiving the abnormal state signal.

After switching the current security mode of the storage device to the abnormal mode, the security manager may initialize or invalidate (e.g., zeroise) data stored in a security memory device, a security data buffer, and a security data address table at S1630. Then, the security manager may transmit a response to the abnormal state signal at S1640. For example, the response to the abnormal state signal may include a signal indicating that initializing of security data has been completed, but the present disclosure is not limited thereto.

In addition, following the initialization of the security data, the security manager may receive a normal state signal from the storage controller and switch the current security mode of the storage device to the original security mode prior to switching to the abnormal mode in response thereto. The storage controller may monitor whether the storage device has recovered to a normal state, and send the normal state signal to the security management module based on a determination that the storage device has recovered to a normal state.

The flowchart and the description with reference to FIG. 16 are only exemplary, and may be constructed differently in some embodiments. For example, in some embodiments, the order of the steps may be changed, some steps may be performed repeatedly, some steps may be skipped, or some steps may be added.

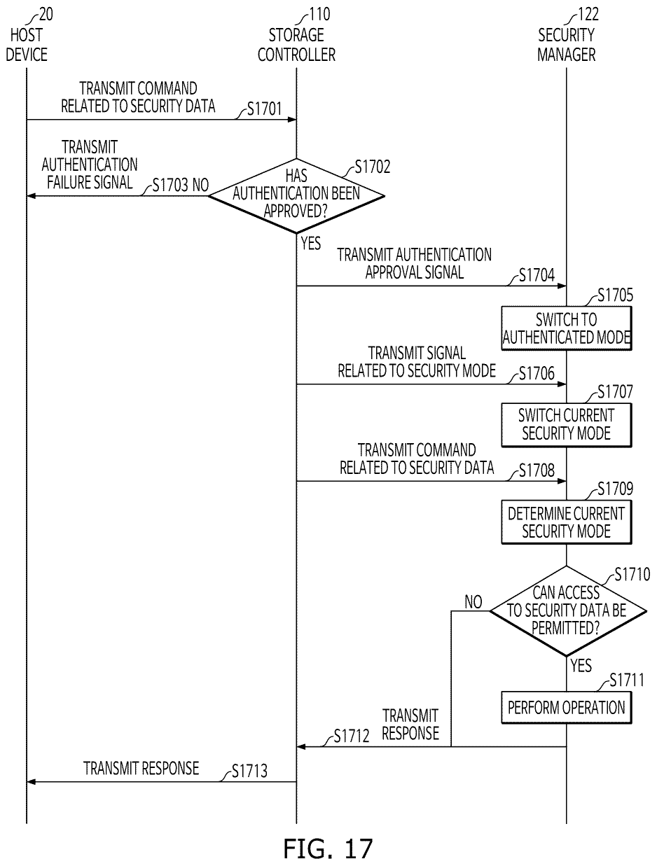

FIG. 17 is a view illustrating an operation method of a storage system according to some embodiments of the present disclosure. Hereinafter, descriptions that overlap with the foregoing descriptions will be skipped or summarized.

Referring to FIG. 17, the host device 20 may transmit a command related to security data to the storage controller 110 at S1701. The command related to security data may include information for requesting allocation of a memory space where the security data is to be stored (e.g., registration operation of FIG. 10), information for requesting reading of the security data (e.g., reading operation of FIG. 12), or information for requesting writing of the security data (e.g., writing operation of FIG. 11), but the present disclosure is not limited thereto.

In response to receiving the command related to security data from the host device 20, the storage controller 110 may perform an authentication procedure on the host device 20 and determine whether authentication has been approved at S1702. In one embodiment, as part of the authentication procedure, in response to receiving the command related to security data from the host device 20, the storage controller 110 may verify whether the subject attempting to access a storage device through the host device 20 can be trusted. When an authentication request from the host device 20 has not been approved, the storage controller 110 may transmit an authentication failure signal to the host device 20 at S1703. When the authentication request from the host device 20 has not been approved, at least some of the remaining steps S1704 to S1713 may not be performed. When the authentication request from the host device 20 has been approved, the storage controller 110 may transmit an authentication approval signal to the security manager 122 at S1704.

In response to receiving the authentication approval signal from the storage controller 110, the security manager 122 may switch the current security mode of the storage device to the authenticated mode at S1705.

After the current security mode has been switched to the authenticated mode at S1705, the storage controller 110 may transmit a signal related to a security mode to the security manager 122 at S1706. In one embodiment, the signal related to a security mode may include any one of an initialization signal, a debug signal, and an abnormal state signal. In response to receiving the signal related to a security mode from the storage controller 110, the security manager 122 may switch the current security mode of the storage device to a mode related to the received signal at S1707. For example, the current security mode may be switched to the initialization mode if the signal related to a security mode includes an initialization signal, or the current security mode may be switched to the debug mode if the signal related to a security mode includes a debug signal, or the current security mode may be switched to the abnormal mode if the signal related to a security mode includes an abnormal signal.

The storage controller 110 may transmit a command related to security data to the security manager 122 at S1708. In response to receiving the command related to security data from the storage controller 110, the security manager 122 may determine the current security mode of the storage device at S1709. In addition, based on the current security mode of the storage device, the security manager 122 may determine whether access to the security data can be permitted at S1710.

When the security manager 122 determines that access to the security data can be permitted, the security manager 122 may perform an operation related to the received command at S1711. In one embodiment, the security manager 122 may access at least one of a security memory device, a security data buffer, a security data address table, and an external memory device to perform an operation related to the received command. The received command may be, for example, a reading command, a writing command, etc. In one embodiment, the security manager 122 may switch the security mode of the storage device from the authenticated mode to the unauthenticated mode after performing the operation related to the received command.

Thereafter, the security manager 122 may transmit a response including the result of performing the operation to the storage controller 110 at S1712. Here, the response including the result of performing the operation may include at least one of a signal indicating that allocation of a memory space where the security data is to be stored has been completed, a signal indicating that an operation of writing the security data has been completed, the security data that has been read out, and a signal indicating that an operation of reading the security data has been completed, but the present disclosure is not limited thereto.

When the security manager 122 determines that access to the security data is not permitted, the security manager 122 may transmit a response including a no access signal to the storage controller 110 at S1712.

Then, the storage controller 110 may transmit a response to the command to the host device 20 based on the response received from the security manager 122 at S1713. In one embodiment, when a requested operation has been performed, the response to the command may include a response including the result of carrying out the operation, and, when the requested operation has not been performed, the response to the command may include a response including the no access signal.

In FIG. 17, S1701 to S1705, which relate to the authentication procedure, are performed before S1706 to S1707, which relate to the security mode switching, but the present disclosure is not limited thereto. Rather, in some embodiments, S1701 to S1705 related to the authentication procedure may be carried out after S1706 to S1707 related to the security mode switching, or at least some of S1701 to S1705 related to the authentication procedure and at least one of S1706 to S1707 related to the security mode switching may be performed in parallel. In addition, S1706 to S1707 related to the security mode switching may be skipped depending on the state of the storage device.

In some embodiments, the operations performed by the security manager 122, which have been described above with reference to FIG. 17, may also be carried out by a second processor core, e.g., the second processor core 920 in FIG. 9, of the storage controller 110.

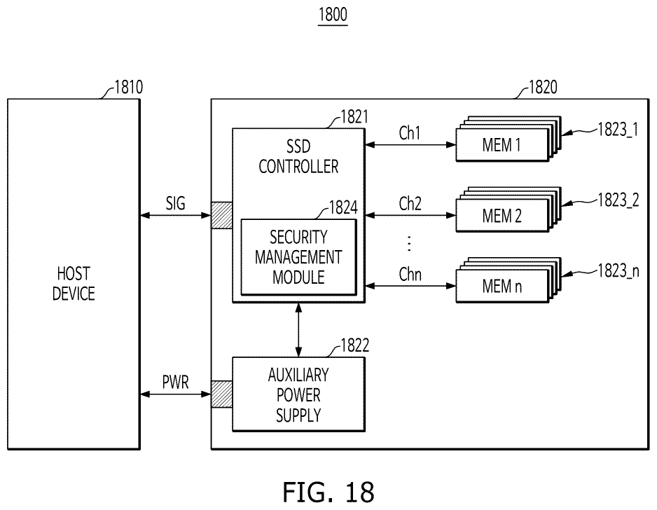

FIG. 18 is a block diagram for showing an example of how a storage system according to one embodiment of the present disclosure is applied to an SSD system 1800.

Referring to FIG. 18, the SSD system 1800 may include a host device 1810 and an SSD 1820. The SSD 1820 may exchange signals SIG with the host device 1810 through a signal connector, and may receive power PWR through a power connector. The SSD 1820 may include an SSD controller 1821, an auxiliary power supply 1822, and memory devices (1823_1, 1823_2, . . . , 1823_n, where n is a natural number equal to or greater than two). Here, the SSD controller 1821 may exchange commands, addresses, data, etc. with each of the memory devices (1823_1, 1823_2, . . . , 1823_n, where n is a natural number equal to or greater than two) through each channel (Ch1, Ch2, . . . , Chn, where n is a natural number equal to or greater than two).

In one embodiment, the memory devices (1823_1, 1823_2, . . . , 1823_n) may be vertically stacked NAND flash memory devices. In this case, the SSD 1820 may be formed by applying the embodiments illustrated in FIGS. 1 to 17. That is, the SSD controller 1821 included in the SSD 1820 may include a security management module 1824 designed to manage security data. The security management module 1824 may manage the security mode of the SSD 1820, control access to itself based on the current security mode of the SSD 1820, and perform operations related to the security data.

1. A storage device comprising:
a memory device; and
a storage controller comprising a security management module for managing security data of the storage device,
wherein the security management module comprises:
a security manager that is configured to receive a command related to the security data, determine a current security mode of the storage device in response to receiving the command, and control access to the security data based on the current security mode, wherein the current security mode comprises one of a first security mode, in which the security manager is configured to allow access to the security data, a second security mode, in which the security manager is configured to allow limited access to the security data, and a third security mode, in which the security manager is configured to block access to the security data.

2. The storage device as claimed in claim 1, wherein the security management module further comprises a security memory device configured to store at least some of the security data and a security data buffer configured to temporarily store first security data read out from the security memory device, wherein the first security data is a portion of the security data stored by the security memory device, and
the security manager is configured to read out the first security data temporarily stored in the security data buffer when performing a reading operation on the security memory device.

3. The storage device as claimed in claim 2, wherein the third security mode of the storage device comprises an unauthenticated mode, and
the security manager blocks access to the security data in response to a determination that the current security mode is the unauthenticated mode.

4. The storage device as claimed in claim 3, wherein the first security mode comprises an authenticated mode,
the storage controller is configured to determine whether to approve an authentication request from a host device and, in response to approval of the authentication request, transmit an authentication approval signal to the security management module, and
the security manager is configured to switch the current security mode from the unauthenticated mode to the authenticated mode in response to receiving the authentication approval signal, and, in response to a determination that the current security mode is the authenticated mode, the security manager is configured to allow performance of at least one of a reading operation or a writing operation on the security memory device.

5. The storage device as claimed in claim 4, wherein, in response to completion of at least one of a reading operation or a writing operation on the security memory device, the security manager is configured to switch the current security mode from the authenticated mode to the unauthenticated mode.

6. The storage device as claimed in claim 4, wherein the second security mode comprises a zeroised mode,
the storage controller is configured to, in response to an initialization request from the host device, transmit an initialization signal to the security management module, and
the security manager is configured to, in response to receiving the initialization signal, switch the current security mode from the authenticated mode to the zeroised mode, and, in response to a determination that the current security mode is the zeroised mode, initialize security data stored in each of the security memory device and the security data buffer.

7. The storage device as claimed in claim 6, wherein the security manager, in response to a determination that the current security mode is the zeroised mode, is configured to allow performance of a reading operation on the security memory device and block performance of a writing operation on the security memory device.

8. The storage device as claimed in claim 2, wherein the second security mode of the storage device comprises a debug mode,
the storage controller is configured to monitor a debugging state of the storage device and transmit a debugging signal to the security management module based on the monitored debugging state, and
in response to receiving the debugging signal, the security manager is configured to switch the current security mode to the debug mode, and, in response to a determination that the current security mode is the debug mode, the security manager is configured to initialize the first security data stored in the security data buffer.

9. The storage device as claimed in claim 8, wherein the security manager is configured to, in response to a determination that the current security mode is the debug mode, allow performance of a reading operation on the security data buffer and block performance of a writing operation on the security memory device.

10. The storage device as claimed in claim 2, wherein the third security mode of the storage device comprises an abnormal mode,
the storage controller is configured to monitor whether the storage device is in an abnormal state and, based on a determination that the storage device is in the abnormal state, transmit an abnormal state signal to the security management module indicating that the storage device is in the abnormal state, and
in response to receiving the abnormal state signal, the security manager is configured to switch the current security mode to the abnormal mode, and, in response to a determination that the current security mode is the abnormal mode, the security manager is configured to initialize security data stored in each of the security memory device and the security data buffer.

11. The storage device as claimed in claim 10, wherein, in response to a determination that the current security mode is the abnormal mode, the security manager is configured to block performance of a reading operation and a writing operation on the security memory device.

12. The storage device as claimed in claim 2, wherein the security management module further comprises a security data address table for managing address data of the security data, the security data address table being managed by the security manager, and
the security manager stores, in the security data address table, a start address and an end address of the security data.

13. The storage device as claimed in claim 12, further comprising an external memory device that stores some of the security data, wherein the external memory device is separate from the security management module, and the external memory device is configured to be accessed by the security manager, wherein
the security manager is configured to store information in the security data address table indicating that the security data has been stored in the external memory device,
the security data buffer is configured to temporarily store second security data read out from the external memory device, wherein the second security data is a portion of the security data stored by the external memory device, and
the security manager is configured to read out the second security data temporarily stored in the security data buffer when performing a reading operation on the external memory device.

14. A storage device comprising:
a memory device; and
a storage controller comprising a first processor core for controlling non-security-related operations of the storage device, a second processor core for controlling security operations of the storage device, and a security management module configured to be accessed by the second processor core,
wherein the security management module comprises a security memory device configured to store at least some of security data of the storage device and a security data buffer configured to temporarily store first security data read out from the security memory device, wherein the first security data is a portion of the security data stored by the security memory device,
the second processor core is configured to receive a command related to the security data, determine a current security mode of the storage device in response to receiving the command related to the security data, and determine whether to perform an operation related to the security memory device based on the current security mode, and
the second processor core is configured to read out the first security data temporarily stored in the security data buffer when performing a reading operation on the security memory device.

15. The storage device as claimed in claim 14, wherein one of the security modes of the storage device is an unauthenticated mode, and
in response to a determination that the current security mode is the unauthenticated mode, the second processor core is configured to block performance of an operation on the security memory device.

16. The storage device as claimed in claim 15, wherein one of the security modes is an authenticated mode, and
the second processor core is configured to determine whether to approve an authentication request from a host device, and, in response to approval of the authentication request, switch the current security mode to the authenticated mode, and allows performance of at least one of a reading operation or a writing operation on the security memory device in response to a determination that the current security mode is the authenticated mode.

17. The storage device as claimed in claim 16, wherein one of the security modes is a zeroised mode,
the first processor core is configured to, in response to an initialization request from the host device, transmit an initialization signal to the second processor core, and
the second processor core is configured to, in response to receiving the initialization signal, switch the current security mode from the authenticated mode to the zeroised mode, and, in response to a determination that the current security mode is the zeroised mode, initialize security data stored in each of the security memory device and the security data buffer.

18. The storage device as claimed in claim 14, wherein one of the security modes is a debug mode,
the first processor core is configured to monitor a debugging state of the storage device and transmit a debugging signal to the second processor core based on the monitored debugging state, and
in response to receiving the debugging signal, the second processor core is configured to switch the current security mode to the debug mode, and, in response to a determination that the current security mode is the debug mode, the second processor core is configured to initialize the first security data stored in the security data buffer.

19. The storage device as claimed in claim 14, wherein one of the security modes is an abnormal mode,
the first processor core monitors whether the storage device is in an abnormal state and, based on a determination that the storage device is in the abnormal state, is configured to transmit an abnormal state signal to the second processor core indicating that the storage device is in the abnormal state, and
in response to receiving the abnormal state signal, the second processor core is configured to switch the current security mode to the abnormal mode, and, in response to a determination that the current security mode is the abnormal mode, the second processor core is configured to initialize security data stored in each of the security memory device and the security data buffer.

20. A storage device comprising:
a memory device; and
a storage controller comprising a first processor core for controlling non-security-related operations of the storage device, a second processor core for controlling security operations of the storage device, and a security management module configured to be accessed by the second processor core,
wherein the security management module comprises:
a security memory device configured to store a first portion of security data of the storage device;
an external memory device configured to store a second portion of the security data, wherein the external memory device is configured to be accessed by the second processor; and
a security data buffer configured to temporarily store security data read out from the security memory device or the external memory device,
wherein a current security mode of the storage device comprises one of an unauthenticated mode, an authenticated mode, a zeroised mode, a debug mode, and an abnormal mode,
the second processor core is configured to receive a command related to the security data, determine the current security mode of the storage device in response to receiving the command related to the security data, and control access to the security memory device and the external memory device based on the determined current security mode, and
the second processor core is configured to read out the security data temporarily stored in the security data buffer when performing a reading operation on the security memory device or the external memory device.
